(19) United States
(12) Patent Application Publication
(10) Pub. No.: US 2015/0298434 A1
(43) Pub. Date: Oct. 22, 2015

(54) RUBBER LAMINATE

(71) Applicant: UNIMATE CO., LTD., Minato-ku, Tokyo (JP)

(72) Inventors: Hideyuki Ono, Ibaraki (JP); Tamotu Yoshida, Ibaraki (JP)

(21) Appl. No.: 14/440,663

(22) PCT Filed: Nov. 1, 2013
(86) PCT No.: PCT/JP2013/079742

§ 371 Date: May 5, 2015

(30) Foreign Application Priority Data
Nov. 6, 2012 (JP) 2012-244158

(51) Int. Cl. B32B 25/04; B32B 25/14

(52) U.S. Cl. CPC B32B 25/042; B32B 25/14; B32B 2250/02; B32B 2250/248; B32B 2305/77; B32B 2305/72; B32B 2307/308

(57) ABSTRACT

A rubber laminate comprising an unvulcanized carboxyl group-containing acrylic rubber layer and an unvulcanized polyol-crosslinkable fluororubber layer that are integrally bonded by vulcanization;
the unvulcanized carboxyl group-containing acrylic rubber layer comprising an aromatic polyvalent amine compound; 1,8-diazabicyclo[5.4.0]undecene-7, 1,5-diazabicyclo[4.3.0]nonene-5, or a salt thereof; and a guanidine compound;
the guanidine compound being used at a ratio of 3 to 8 parts by weight, preferably 4 to 6 parts by weight, based on 100 parts by weight of unvulcanized carboxyl group-containing acrylic rubber. The rubber laminate has excellent scorch stability of the unvulcanized acrylic rubber layer and excellent adhesion.

### TECHNICAL FIELD

The present invention relates to a rubber laminate. More particularly, the present invention relates to a fluororubber/acrylic rubber laminate.

### BACKGROUND ART

For fuel hoses, rubber laminates having an inner layer comprising fluororubber and an outer layer comprising epichlorohydrin-based rubber were initially used (Patent Documents 1 and 2). However, the heat resistance of such rubber laminates was not sufficient in a high-temperature atmosphere near an engine. Fluororubber/acrylic rubber laminates having excellent heat resistance were required for this type of application (Patent Document 3).

Regarding the rubber laminate and hose disclosed in Patent Document 3, an unvulcanized epoxy group-containing acrylic rubber layer and an unvulcanized fluororubber layer containing a silica-based filler are peroxide-cocrosslinked to form a laminate; however, the use of epoxy group-containing acrylic rubber causes the problems of inferior heat resistance and compression set characteristics.

Fluororubber is expensive, so that it is rarely used alone as a hose material. In general, fluororubber is often used as a laminated hose with other rubber materials. Patent Document 3 mentioned above is one such example; however, there is a problem in that fluororubber generally has poor vulcanization adhesion to other rubber materials.

In order to improve scorch stability and compression set characteristics, it is known to add a 1,8-diazabicyclo[5.4.0]undecene-7 salt [DBU salt] or a 1,5-diazabicyclo[4.3.0]nonene-5 salt [DBN salt] to acrylic rubber (Patent Document 4); however, there is a problem in that the addition of a DBU salt or a DBN salt to carboxyl group-containing acrylic rubber results in a short scorch time (t5). Molded products such as a hose obtained by extrusion molding having short scorch times have the problem of material burned spot during extrusion, resulting in a higher failure rate.

Moreover, Patent Document 5 discloses a rubber laminate comprising an unvulcanized rubber layer containing fluororubber as a main component and an unvulcanized rubber layer not containing fluororubber, wherein when these rubber layers are superimposed and vulcanized, hydrochloride, sulfonate, or phenoxide of DBU or DBN, and an oxide, hydroxide, or carbonate of a metal of Group II to IV are mixed in at least one layer. As the rubber used in the unvulcanized rubber layer not containing fluororubber, acrylic rubber and an acrylic copolymer obtained by copolymerization of α,β-ethylenically unsaturated carboxylic acid are mentioned. Various hoses are mentioned as specific applications of the rubber laminate; however, this case also has the same problems as in Patent Document 4.

### PRIOR ART DOCUMENTS

### Patent Documents

Patent Document 1 : JP-A-58-103555

Patent Document 2 : JP-A-2-160867

Patent Document 3 : JP-A-2000-6317

Patent Document 4 : JP-A-11-80488

Patent Document 5 : JP-A-62-282928

### OUTLINE OF THE INVENTION

### Problem to be Solved by the Invention

An object of the present invention is to provide a fluororubber/acrylic rubber laminate that is a laminate of carboxyl group-containing acrylic rubber and fluororubber, and that has excellent scorch stability of the unvulcanized acrylic rubber layer and excellent adhesion.

### Means for Solving the Problem

Such an object of the present invention is achieved by a rubber laminate comprising an unvulcanized carboxyl group-containing acrylic rubber layer and an unvulcanized polyol-crosslinkable fluororubber layer that are integrally bonded by vulcanization;

the unvulcanized carboxyl group-containing acrylic rubber layer comprising an aromatic polyvalent amine compound; 1,8-diazabicyclo[5.4.0]undecene-7, 1,5-diazabicyclo[4.3.0]nonene-5, or a salt thereof; and a guanidine compound;

the guanidine compound being used at a ratio of 3 to 8 parts by weight, preferably 4 to 6 parts by weight, based on 100 parts by weight of unvulcanized carboxyl group-containing acrylic rubber.

### Effect of the Invention

The present invention provides a fluororubber/acrylic rubber laminate that is a laminate of carboxyl group-containing acrylic rubber and fluororubber, and that has excellent scorch stability of the unvulcanized acrylic rubber layer and excellent adhesion.

Fluororubber has inferior vulcanization adhesion to other rubbers. To bond fluororubber and acrylic rubber by vulcanization, it is necessary to form a chemical or physical bond in the interfacial region between the fluororubber and the acrylic rubber. The laminate of the present invention enables cocrosslinking of fluororubber and acrylic rubber, and has excellent scorch stability of the unvulcanized acrylic rubber layer that enables extrusion molding.

The addition of a DBU salt or a DBN salt to the carboxyl group-containing acrylic rubber is considered to promote the de-HF reaction from the fluororubber in the interfacial region, and to induce subsequent crosslinking reaction due to bonding of an aromatic polyvalent amine compound, which is a vulcanizing agent in the acrylic rubber composition, to the fluororubber.

Further, the addition of a guanidine compound to the acrylic rubber composition is considered to contribute to, as a base, the promotion of the crosslinking reaction of acrylic rubber. In addition, the use of the compound in a larger amount is considered to contribute to, as a guanidine compound, the scorch stability of the unvulcanized acrylic rubber layer, because the compound coordinates with the carboxyl group of the acrylic rubber to interfere with the reaction between the carboxyl group and the amine group, thereby delaying the reaction.

### EMBODIMENTS FOR CARRYING OUT THE INVENTION

Examples of the carboxyl group-containing acrylic rubber that forms an unvulcanized carboxyl group-containing acrylic rubber layer containing DBU (salt) or DBN (salt) include those obtained by copolymerization of a carboxyl group-containing unsaturated compound and at least one of an alkyl acrylate containing an alkyl group having 1 to 8 carbon atoms and an alkoxyalkyl acrylate containing an alkoxyalkyl group having 2 to 8 carbon atoms.

Examples of alkyl acrylates include methyl acrylate, ethyl acrylate, propyl acrylate, isopropyl acrylate, n-butyl acrylate, n-hexyl acrylate, 2-ethylhexyl acrylate, n-octyl acrylate, and their corresponding methacrylates. Alkyl groups having a longer chain length are generally advantageous in terms of cold resistance, but are disadvantageous in terms of oil resistance. Alkyl groups having a shorter chain length show an opposite tendency. In terms of the balance between oil resistance and cold resistance, ethyl acrylate and n-butyl acrylate are preferably used.

Moreover, examples of alkoxyalkyl acrylates include methoxymethyl acrylate, methoxyethyl acrylate, ethoxyethyl acrylate, n-butoxyethyl acrylate, ethoxypropyl acrylate, and the like; preferably 2-methoxyethyl acrylate and 2-ethoxyethyl acrylate. Although each of such alkoxyalkyl acrylates and alkyl acrylates may be used singly, it is preferable that the former is used at a ratio of 60 to 0 wt. %, and that the latter is used at a ratio of 40 to 100 wt. %. When an alkoxyalkyl acrylate is copolymerized, oil resistance and cold resistance are well balanced. However, when the copolymerization ratio of alkoxyalkyl acrylate is greater than this range, normal state physical properties and heat resistance tend to decrease.

Examples of the carboxyl group-containing unsaturated compound include unsaturated dicarboxylic acid monoalkyl esters of maleic acid or fumaric acid, such as methyl, ethyl, propyl, isopropyl, n-butyl, and isobutyl esters; and unsaturated dicarboxylic acid monoalkyl esters of itaconic acid or citraconic acid, such as methyl, ethyl, propyl, isopropyl, n-butyl, and isobutyl esters; and maleic acid mono-n-butyl ester, fumaric acid monoethyl ester, and fumaric acid mono-n-butyl ester are preferably used. In addition to them, unsaturated monocarboxylic acid such as acrylic acid or methacrylic acid is used. These carboxyl group-containing unsaturated compounds are used at a copolymerization ratio of about 0.5 to 10 wt %, preferably about 1 to 7 wt %, in a carboxyl group-containing acrylic elastomer. When the copolymerization ratio is lower than the above, the vulcanization is insufficient thereby to deteriorate the value of compression set. On the other hand, a copolymerization ratio higher than the above readily causes scorching. Incidentally, since the copolymerization reaction is performed in such a manner that the polymerization conversion rate is 90% or more, the weight ratio of each charged monomer is approximately the copolymer component weight ratio of the resulting copolymer.

In the carboxyl group-containing acrylic elastomer, another copolymerizable ethylenic unsaturated monomer, such as styrene, α-methylstyrene, vinyltoluene, vinylnaphthalene, (meth)acrylonitrile, acrylic acid amide, vinyl acetate, cyclohexyl acrylate, benzyl acrylate, 2-hydroxyethyl acrylate, 4-hydroxybutyl acrylate, ethylene, propylene, piperylene, butadiene, isoprene, or pentadiene, can be further copolymerized at a ratio of about 50 wt % or less. Specific examples include an ethylene-methyl acrylate-monomethyl maleate terpolymer (Vamac HG, produced by Du Pont), and the like.

Furthermore, in order to improve kneading processability, extrusion processability, and other properties, a polyfunctional (meth)acrylate or oligomer containing a glycol residue in the side chain can be further copolymerized, if necessary. Examples thereof include di(meth)acrylates of alkylene glycols, such as ethylene glycol, propylene glycol, 1,4-butanediol, 1,6-hexanediol, 1,9-nonanediol, and neopentyl glycol; di(meth)acrylates of polyalkylene glycols, such as tetraethylene glycol, tripropylene glycol, and polypropylene glycol; bisphenol A.ethylene oxide adduct diacrylate, dimethylol tricyclodecane diacrylate, glycerol methacrylate acrylate, 3-acryloyloxyglycerol monomethacrylate, and the like.

The carboxyl group-containing acrylic elastomer is vulcanized by an aromatic polyvalent amine compound vulcanizing agent. Examples of the aromatic polyvalent amine compound include 4,4′-methylenedianiline, p,p′-ethylenedianiline, m- or p-phenylenediamine, 3,4′-diaminodiphenylether, 4,4′-diaminodiphenylether, 4,4′-diaminodiphenylsulfone, 4,4′-(m- or p-phenylenediisopropylidene)dianiline, 2,2-bis[4-(4-aminophenoxy)phenyl]propane, 2,2-bis[4-(3-aminophenoxy)phenyl]propane, bis[4-(4-aminophenoxy)phenyl]sulfone, bis[4-(3-aminophenoxy)phenyl]sulfone, 4,4′-bis(4-aminophenoxy)biphenol, bis[4-(4-aminophenoxy)phenyl]ether, 2,2-bis[4-(4-aminophenoxy)phenyl]hexafluoropropane, 1,4-bis(4-aminophenoxy)benzene, and 1,3-bis(4-aminophenoxy)benzene, etc., preferably aromatic diamines, more preferably p-substituted aromatic diamines, are used. Such an aromatic polyvalent amine compound vulcanizing agent is used at a ratio of about 0.1 to 5 parts by weight, preferably about 0.2 to 4 parts by weight, based on 100 parts by weight of the carboxyl group-containing acrylic elastomer. When the ratio of the vulcanizing agent is less than this range, vulcanization is insufficient, and sufficient compression set characteristics are not obtained. Moreover, when an aliphatic polyvalent amine compound is used as a vulcanizing agent, scorch stability is not improved, as shown in the results of Comparative Example 6, provided later.

Such a vulcanizing agent is used in combination with 1,8-diazabicyclo[5.4.0]undecene-7 [DBU](salt) or 1,5-diazabicyclo[4.3.0]nonene [DBN] (salt). DBU (salt) or DBN (salt) is used at a ratio of about 0.1 to 5 parts by weight, preferably about 0.5 to 3 parts by weight, based on 100 parts by weight of the unvulcanized carboxyl group-containing acrylic rubber. When DBU or DBN is used in the form of a salt, octylate, sulfonate, o-phthalate, hydrochloride, phenoxide, quaternary ammonium salt, or the like is used. Examples of sulfonates include benzenesulfonate, dodecylbenzenesulfonate, o-, m-, or p-toluenesulfonate, 2,4-ditoluenesulfonate, sulfanilate, naphthalenesulfonate, naphthionate, p-sulfobenzoate, and the like.

DBU (salt) or DBN (salt) is used in combination with a guanidine compound, which is also one type of vulcanization accelerator. Examples of guanidine compounds include diphenylguanidine, tetramethylguanidine, tetraethylguanidine, di-o-tolylguanidine, di-o-tolylguanide, di-o-tolylguanidine salt of dicatechol borate, and the like; preferably 1,3-di-o-tolylguanidine.

Such a guanidine compound is used at a ratio of about 3 to 8 parts by weight, preferably about 4 to 6 parts by weight, based on 100 parts by weight of the unvulcanized carboxyl group-containing acrylic rubber. When the ratio of the guanidine compound is less than this range, the Mooney scorch test shows lower t5 values, and extrusion-molding properties are impaired, as shown in the results of Comparative Examples 1 and 3 to 5, provided later. In contrast, when the ratio of the guanidine compound is greater than this range, peeling strength is reduced, as shown in the results of Comparative Example 2, provided later.

To the unvulcanized carboxyl group-containing acrylic rubber composition comprising the above components as essential components, generally used various compounding agents, such as fillers (e.g., carbon black, silica, graphite, clay, and talc), plasticizers, lubricants, processing aids, and antioxidants, are suitably added. These components are kneaded using a closed-type kneader and an open roll to form a composition.

The unvulcanized carboxyl group-containing acrylic rubber layer formed from the composition of these components is integrally bonded to an unvulcanized polyol-crosslinkable fluororubber layer. The fluororubber layer is formed from an unvulcanized polyol-crosslinkable fluororubber composition.

The fluororubber to be vulcanized by a polyol vulcanizing system is a highly fluorinated elastomeric copolymer. For example, copolymers of vinylidene fluoride and other fluorine-containing olefins can be used. Specific examples thereof include copolymers of vinylidene fluoride and one or more of hexafluoropropylene, pentafluoropropylene, trifluoroethylene, trifluorochloroethylene, tetrafluoroethylene, vinyl fluoride, perfluoroacrylic acid ester, perfluoroalkyl acrylate, perfluoro(methyl vinyl ether), perfluoro(ethyl vinyl ether), perfluoro(propyl vinyl ether), and the like; preferably used are vinylidene fluoride-hexafluoropropylene copolymers and vinylidene fluoride-tetrafluoroethylene-hexafluoropropylene terpolymers.

For example, at least one of the following commercial products is practically used as it is:

Viton E45 (vinylidene fluoride-hexafluoropropylene copolymer) and Viton A-200 (Mooney viscosity: 20; vinylidene fluoride-hexafluoropropylene copolymer, F content: 66%), produced by DuPont;

Tecnoflon N60HS (Mooney viscosity: 28; vinylidene fluoride-hexafluoropropylene copolymer, F content: 66%), produced by Solvay Solexis;

FC-2120 (Mooney viscosity: 23), FC-2122 (Mooney viscosity: 25), FC-2123 (Mooney viscosity: 25), FC-2170 (Mooney viscosity: 31), FC-2174 (Mooney viscosity: 40), FC-2176 (Mooney viscosity: 30), FC-2177 (Mooney viscosity: 33), FC-3009 (Mooney viscosity: 30), FE-5620Q (Mooney viscosity: 23), FE-5621 (Mooney viscosity: 23), and FE-5641Q (Mooney viscosity: 40) <the foregoing, vinylidene fluoride-hexafluoropropylene copolymers, F content: 65.9%>; FLS-2530 (Mooney viscosity: 38) <Vinylidene fluoride-hexafluoropropylene copolymer, F content: 69.0%>; and FE-5840Q (Mooney viscosity: 37) <vinylidene fluoride-hexafluoropropylene-tetrafluoroethylene terpolymer, F content: 70.1%>; produced by Dyneon.

Further, a polyhydroxy aromatic compound is used as a vulcanizing agent for the fluororubber. Examples of polyhydroxy aromatic compounds include 2,2-bis(4-hydroxyphenyl)propane [bisphenol A], 2,2-bis(4-hydroxyphenyl)perfluoropropane [bisphenol AF], hydroquinone, catechol, resorcin, 4,4′-dihydroxydiphenyl, 4,4′-dihydroxydiphenylmethane, 4,4′-dihydroxydiphenylsulfone, 2,2-bis(4-hydroxyphenyl)butane, and the like; preferably used are bisphenol A, bisphenol AF, hydroquinone, and the like. These may be in the form of alkali metal salts or alkaline earth metal salts. Such a vulcanizing agent is used at a ratio of about 0.5 to 10 parts by weight, preferably about 0.5 to 6 parts by weight, based on 100 parts by weight of the polyol-crosslinkable fluororubber. When the ratio of the vulcanizing agent used is less than this range, crosslinking density is insufficient. In contrast, when the ratio is greater than this range, crosslinking density is overly high, and rubber-like elasticity tends to be lost.

It is preferable to use an acid acceptor in the vulcanization of polyol-crosslinkable fluororubber. Examples of acid acceptors include oxides or hydroxides of divalent metals, such as oxides or hydroxides of magnesium, calcium, barium, lead, or zinc; hydrotalcite-related analogous compounds; and the like. The acid acceptor is used at a ratio of about 1 to 20 parts by weight, preferably about 3 to 10 parts by weight, based on 100 parts by weight of the polyol-crosslinkable fluororubber.

Furthermore, a vulcanization accelerator, such as a quaternary onium salt (quaternary ammonium salt or quaternary phosphonium salt), an N-alkyl-substituted amide compound, an active hydrogen-containing aromatic compound-quaternary phosphonium salt equimolecular compound, a divalent metal amine complex compound, or the like, can also be used at a ratio of about 10 parts by weight or less, preferably about 0.1 to 5 parts by weight, based on 100 parts by weight of the polyol-crosslinkable fluororubber.

The fluororubber composition comprising the above components as essential components may further contain, if necessary, a reinforcing agent a plasticizer, a processing aid, a vulcanization aid, etc. These components are kneaded using a closed-type kneader, open roll, or the like, thereby forming composition.

The unvulcanized carboxyl group-containing acrylic rubber composition and the unvulcanized polyol-crosslinkable fluororubber composition are co-extruded into tube shapes by, for example, an extrusion-molding method and laminated, followed by steam vulcanization at a temperature of about 150 to 180° C. at a surface pressure of about 0.4 to 0.7 MPa for about 20 to 60 minutes, and further followed by oven vulcanization (secondary vulcanization) at a temperature of about 150 to 180° C. for about 2 to 10 hours, thereby forming an acrylic rubber/fluororubber laminate.

The obtained acrylic rubber/fluororubber laminates are used as various rubber hoses, etc. For use as rubber hoses, they are generally formed from an acrylic rubber layer having a thickness of 2 to 5 mm, and a fluororubber layer having a thickness of 0.2 to 1.5 mm. In this case, the thickness of the fluororubber layer is preferably small in terms of cost; however, a certain degree of thickness is required in terms of fuel permeability.

### EXAMPLES

The following describes the present invention with reference to Examples.

### Example 1

| | | | |
|---|---|---|---|
| (1) | Carboxyl group-containing acrylic rubber | 100 | parts by weight |
| | (NOXTITE PA-522, produced by | | |
| | Unimatec Co., Ltd.) | | |
| | N330 carbon black (Seast 3, produced by | 55 | parts by weight |
| | Tokai Carbon Co., Ltd.) | | |
| | Stearic acid | 1 | part by weight |
| | Liquid paraffin | 2 | parts by weight |
| | 4,4′-Bis(α,α′-dimethylbenzyl)diphenylamine | 2 | parts by weight |
| | Ether ester-based plasticizer | 5 | parts by weight |
| | (ADK CIZER RS-700, produced by | | |
| | Adeka Corporation) | | |
| | 2,2-Bis[4-(4-aminophenoxy)phenyl]propane | 1.4 | parts by weight |
| | 1,3-Di-o-tolylguanidine | 4 | parts by weight |
| | DBU-octylate (U-CAT SA-102, produced by | 1 | part by weight |
| | San-Apro Ltd.) | | |

After the above components were kneaded using an 8-inch roll, an unvulcanized sheet having a thickness of 3 to 4 mm was produced.

| | | | |
|---|---|---|---|
| (2) | Polyol-vulcanizable ternary fluororubber | 100 | parts by weight |
| | (Viton B-600, produced by DuPont) | | |
| | N774 carbon black (Seast GS, produced by | 12 | parts by weight |
| | Tokai Carbon Co., Ltd.) | | |
| | Calcium hydroxide (Caldic #2000, | 6 | parts by weight |
| | produced by Ohmi Chemical Industry | | |
| | Co., Ltd.) | | |
| | Magnesium oxide (Kyowamag #150, | 3 | parts by weight |
| | produced by Kyowa Chemical Industry | | |
| | Co., Ltd.) | | |
| | Bisphenol AF | 2.3 | parts by weight |
| | Benzyltriphenylphosphonium chloride | 1 | part by weight |

After the above components were kneaded using an 8-inch roll, an unvulcanized sheet having a thickness of 3 to 4 mm was produced.

(3) The unvulcanized sheet comprising a carboxyl group-containing acrylic rubber composition and the unvulcanized sheet comprising a polyol-vulcanizable fluororubber composition were superimposed, and press-molded at a temperature of 160° C. at a surface pressure of 10 MPa for 30 minutes, followed by oven vulcanization (secondary vulcanization) at 175° C. for 4 hours, thereby forming an acrylic rubber/fluororubber laminate.

A sample (15×100×5 mm) cut from the obtained rubber laminate was subjected to a peeling test (peeling rate: 50 mm/min) according to JIS K6256. The peeling force was measured, and the bonding state between the rubber layers was visually observed (◯; rubber breakage occurred in the peeled surface; ×: interfacial peeling occurred in the peeled surface).

The below-mentioned table shows the obtained results. The table also shows the results of the Mooney scorch test (measuring 125° C. MLmin and t5 values) performed on the carboxyl group-containing acrylic rubber composition according to JIS K6300 corresponding to ISO 289-1 and ISO 289-2.

### Example 2

In Example 1, the amount of 1,3-di-o-tolylguanidine was changed to 6 parts by weight.

### Example 3

In Example 1, the same amount (1 parts by weight) of DBU-toluenesulfonate (U-CAT SA506, a product of San-Apro Ltd.) was used instead of DBU-octylate.

### Example 4

In Example 1, the same amount (1 parts by weight) of DBU-o-phtalate (U-CAT SA810, a product of San-Apro Ltd.) was used instead of DBU-octylate.

### Example 5

In Example 1, the same amount (1 parts by weight) of DBN-octylate (U-CAT 1120, a product of San-Apro Ltd.) was used instead of DBU-octylate.

### Comparative Example 1

In Example 1, the amount of 1,3-di-o-tolylguanidine was changed to 2 parts by weight.

### Comparative Example 2

In Example 1, the amount of 1,3-di-o-tolylguanidine was changed to 10 parts by weight.

### Comparative Examples 3 to 5

In Examples 3 to 5, the amount of 1,3-di-o-tolylguanidine was changed to 2 parts by weight.

### Comparative Example 6

In Example 1, 0.6 parts by weight of hexamethylenediamine carbamate was used instead of 2,2-bis[4-(4-aminophenoxy)phenyl]propane.

### Comparative Example 7

In Example 1, DBU-octylate was not used.

### Comparative Example 8

In Example 1, 1,3-di-o-tolyl guanidine was not used.

### Comparative Example 9

In Example 1, the same amount (100 parts by weight) of epoxy group-containing acrylic rubber (NOXTITE PA-312, a product of Unimatec Co., Ltd.) was used instead of carboxyl group-containing acrylic rubber.

The results obtained in Examples and Comparative Examples above are shown in the following Table.

TABLE

| | Mooney scorch test | | Bonding test | |
|---|---|---|---|---|
| | | t5 | | Peeling |
| Example | 125° C. MLₘᵢₙ | (min) | Peeling strength (N/mm) | state |
| Example 1 | 30 | 13.6 | 3.9 | ◯ |
| Example 2 | 28 | 22.8 | 4.4 | ◯ |
| Example 3 | 29 | 17.5 | 3.2 | ◯ |
| Example 4 | 30 | 15.3 | 3.0 | ◯ |
| Example 5 | 34 | 14.2 | 3.6 | ◯ |
| Comp. Ex. 1 | 32 | 6.1 | 4.5 | ◯ |
| Comp. Ex. 2 | 24 | 33.8 | 2.4 | X |
| Comp. Ex. 3 | 29 | 7.9 | 3.2 | ◯ |
| Comp. Ex. 4 | 30 | 7.4 | 3.0 | ◯ |
| Comp. Ex. 5 | 34 | 5.9 | 3.6 | ◯ |
| Comp. Ex. 6 | 37 | 4.5 | 4.3 | ◯ |
| Comp. Ex. 7 | 31 | 14.1 | 0.7 | X |
| Comp. Ex. 8 | 33 | 5.0 | 2.2 | X |
| Comp. Ex. 9 | 33 | 10.4 | 1.8 | X |

1. A rubber laminate comprising an unvulcanized carboxyl group-containing acrylic rubber layer and an unvulcanized polyol-crosslinkable fluororubber layer that are integrally bonded by vulcanization;
the unvulcanized carboxyl group-containing acrylic rubber layer comprising an aromatic polyvalent amine compound; 1,8-diazabicyclo[5.4.0]undecene-7, 1,5-diazabicyclo[4.3.0]nonene-5, or a salt thereof; and a guanidine compound;
the guanidine compound being used at a ratio of 3 to 8 parts by weight based on 100 parts by weight of unvulcanized carboxyl group-containing acrylic rubber.

2. The rubber laminate according to claim 1, wherein the carboxyl group-containing acrylic rubber is acrylic rubber in which an unsaturated dicarboxylic acid monoalkyl ester is copolymerized.

3. The rubber laminate according to claim 1, wherein the aromatic polyvalent amine compound is aromatic diamine compound.

4. The rubber laminate according to claim 1, wherein the guanidine compound is 1,3-di-o-tolylguanidine.

5. The rubber laminate according to claim 1, wherein the guanidine compound is used at a ratio of 4 to 6 parts by weight based on 100 parts by weight of the unvulcanized carboxyl group-containing acrylic rubber.

6. The rubber laminate according to claim 4, wherein the guanidine compound is used at a ratio of 4 to 6 parts by weight based on 100 parts by weight of the unvulcanized carboxyl group-containing acrylic rubber.
